(19) United States
(12) Patent Application Publication
(10) Pub. No.: US 2010/0107829 A1
(43) Pub. Date: May 6, 2010

(54) TORQUE LIMITING DRIVER

(75) Inventors: Mark Zimmerman, Columbia City, IN (US); Mark Bryant, Auburn, IN (US); Diane Sung, Liberty Township, OH (US); Greg Stalcup, Columbia City, IN (US); Ryan Schlotterback, Fort Wayne, IN (US)

Correspondence Address: BARNES & THORNBURG LLP, 600 ONE SUMMIT SQUARE, FORT WAYNE, IN, 46802, US

(73) Assignee: NEMCOMED, INC., HICKSVILLE, OH (US)

(21) Appl. No.: 12/606,432

(22) Filed: Oct. 27, 2009

Related U.S. Application Data
(60) Provisional application No. 61/109,539, filed on Oct. 30, 2008.

(51) Int. Cl. B25B 23/153; B25B 23/142; B25B 23/159

(52) U.S. Cl. 81/471; 81/474; 173/1; 81/467

(57) ABSTRACT

A torque limiting driver for applying up to a maximum torque to an associated driven member. In one embodiment, the driver includes first and second rotatable members with proximal and distal ends. A torque limiting assembly may be operatively coupling the distal end of the first rotatable member with the proximal end of the second rotatable member. The torque limiting assembly may include a plurality of torque limiting devices that are arranged to sequentially uncouple the second rotatable member from a torque load applied to the first rotatable member when the torque load exceeds the preselected maximum torque.

### RELATED APPLICATION

The present application claims the benefit of U.S. Provisional Patent Application Ser. No. 61/109,539, filed on Oct. 30, 2008, the entire disclosure of which is hereby incorporated by reference.

### TECHNICAL FIELD

The present invention relates generally to drivers that apply up to a predetermined torque to a device, such as a screw or bolt.

### BACKGROUND

There are many torque limiting devices in the marketplace today, including the medical and automotive industries. Torque limiting wrenches, for example, are used in many different applications to adjust various components including, but not limited to, bolts and fasteners to a specified torque. Such a device can be important to prevent over-torquing.

Torque limiting wrenches used with medical devices are designed to be used multiple times, with re-sterilization after each use. The sterilization process subjects the wrench's components to increased wear and tear. Moreover, re-sterilization causes the accuracy of the device to decrease; thus, hospitals (and other health care providers) continually send instruments to manufacturers for recalibration.

Therefore, there is a need for a novel torque limiting device that overcomes these issues.

### SUMMARY

According to one aspect, the invention provides a torque limiting driver for applying up to a maximum torque to an associated driven member. In one embodiment, the driver includes first and second rotatable members with proximal and distal ends. A torque limiting assembly may be operatively coupling the distal end of the first rotatable member with the proximal end of the second rotatable member. The torque limiting assembly may include a plurality of torque limiting devices that are arranged to sequentially uncouple the second rotatable member from a torque load applied to the first rotatable member when the torque load exceeds the preselected maximum torque.

In some embodiments, the proximal end of the first rotatable member and/or the distal end of the second rotatable member includes a quick connect fastening portion. For example, the quick connect fastening portion could include an opening dimensioned to receive an external device. In some cases, an interference member could be disposed within the opening to frictionally engage the external device. Embodiments are contemplated in which the torque limiting assembly could include a frangible member that is configured to release the second rotatable member from a torque load applied to the first rotatable member when the torque load exceeds the preselected maximum torque. For example, the frangible member could be a shear pin.

According to another aspect, the invention provides a method for driving a device in a torque limited manner. The method includes the step of providing a torque limiting driver having a torque limiting assembly operatively coupling a first rotatable member with a second rotatable member. The torque limiting assembly could include a frangible portion that is configured to shear when a preselected maximum torque is applied to the first rotatable member. Another step could be applying a torque load to the first rotatable member. In response to the torque load on the first rotatable member exceeding the preselected maximum torque, the method includes the step of releasing the second rotatable member from the torque load applied to the first rotatable member by breaking the frangible member.

According to a further aspect, the invention provides a kit for use by a health care provider. In this embodiment, the kit includes at least one medical device. A single-use torque limiting driver is also provided that has an end adapted to be coupled with the medical device. Typically, the single-use torque limiting driver is capable of transferring torque to the medical device up to a preselected maximum torque. For purposes of example only, the health care provider could drive the single-use torque limiting device up to the maximum torque a certain number of times during a medical procedure and then dispose of the single-use torque limiting driver.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is an exploded view of an example torque limiting driver according to an embodiment to the invention;

FIG. 2 is a side view of the example torque limiting driver shown in FIG. 1;

FIG. 3 is a side cross-sectional view of the example torque limiting driver shown in FIG. 1 along line A-A;

FIG. 4 is a perspective view of an example housing for the torque limiting driver according to an embodiment of the invention;

FIGS. 5 and 6 are side cross-sectional views of the example housing shown in

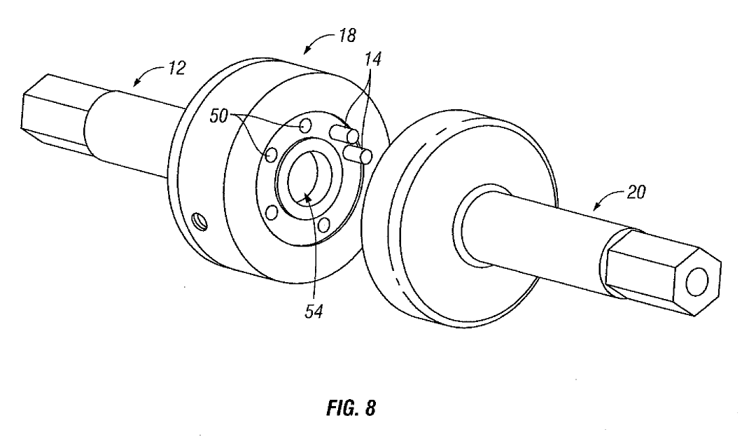

FIG. 4;

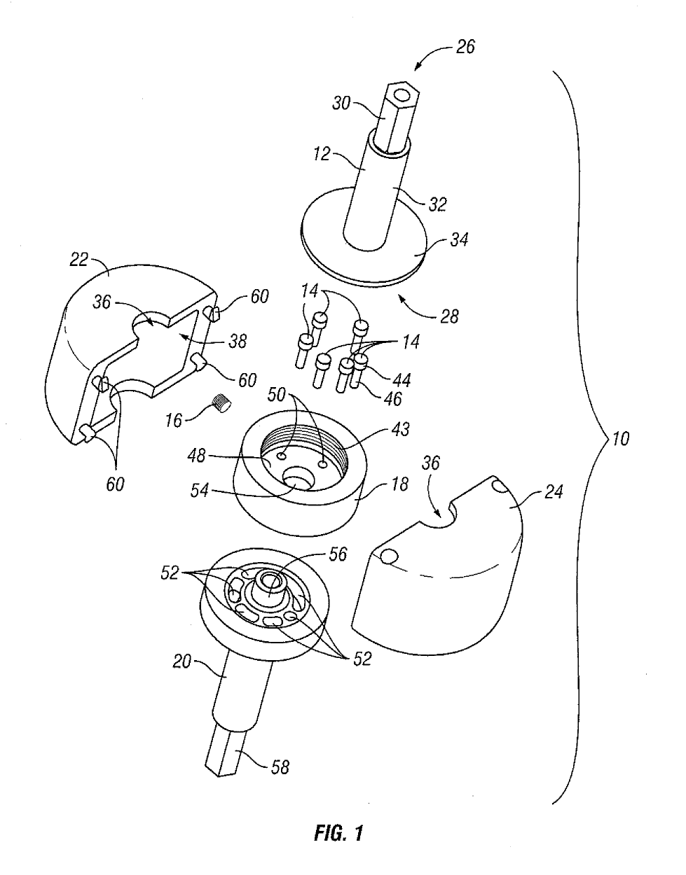

FIG. 7 is a partially-exploded perspective view of the example torque limiting driver shown in FIG. 1 showing the housing exploded;

FIG. 8 is a perspective view of the example torque limiting driver shown in FIG. 1 with the housing removed and the first rotatable member separated from the second rotatable member;

FIG. 9 illustrates a possible step during assembly of the torque limiting driver according to an embodiment of the invention;

FIG. 10 is a side cross-sectional view of an example quick connection prior to coupling according to an embodiment of the invention;

FIG. 11 is a side cross-sectional view of the example quick connection shown in

FIG. 10 after coupling;

FIG. 12 is a front cross-sectional view of the example quick connection shown in FIG. 11; and

FIG. 13 is a side cross-sectional view of an example quick connection according to an alternative embodiment of the invention.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

FIG. 1 shows a torque limiting driver, generally referred to by reference number 10, constructed according to an embodiment of the present invention. While the torque limiting driver 10 will be discussed below in tell is of torquing medical devices, such as bone screws, it should be appreciated that the torque limiting driver 10 could be used in other contexts. The torque limiting driver 10 shown in FIG. 1 includes an input assembly comprising an input member 12, a plurality of shear pins 14, a set screw 16, and a pin retaining member 18. The input assembly operatively couples with an output member 20. As shown, a housing assembly comprises a first housing member 22 and a second housing member 24 surrounding a portion of the input assembly and the output member 20.

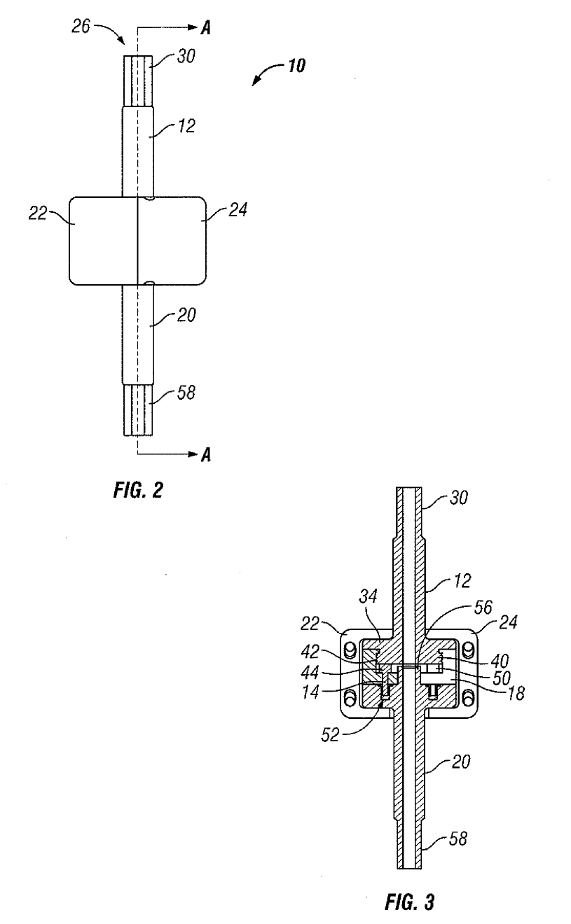

In the embodiment shown, referring now to FIGS. 1-3, the input member 12 includes a first end 26 and a second end 28. As shown, the first end 26 includes a fastener portion 30 adapted to releasably attach a medical instrument, such as a handle. Embodiments are contemplated in which a variety of connection types and styles could be used for the fastener portion 30, including but not limited to a male-type fastener, a female-type fastener, a square connection, and/or an AO style connection. Typically, the fastener portion 30 would be a quick connect, including but not limited to, the embodiments shown in FIGS. 10-13 and discussed below. An input shaft 32 extends between the fastener portion 30 and a shoulder portion 34. As shown, the input shaft 32 is dimensioned to be received by a top opening 36 in the housing assembly. The shoulder portion 34 is dimensioned to be received within a cavity 38 defined by the housing assembly.

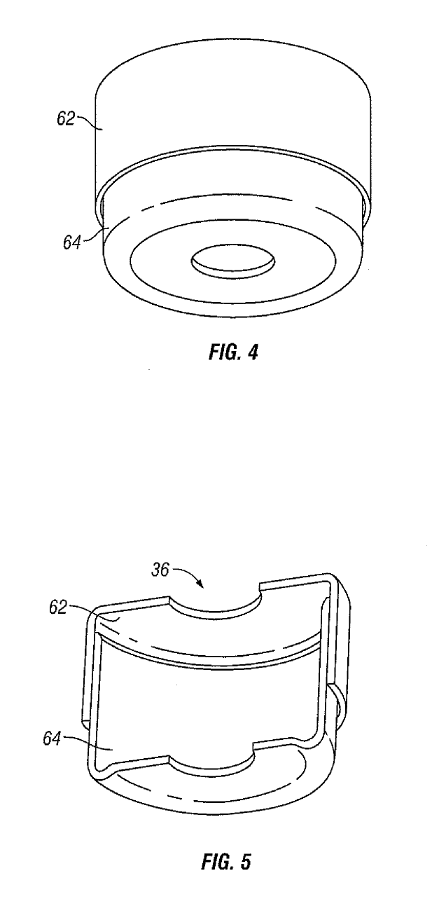

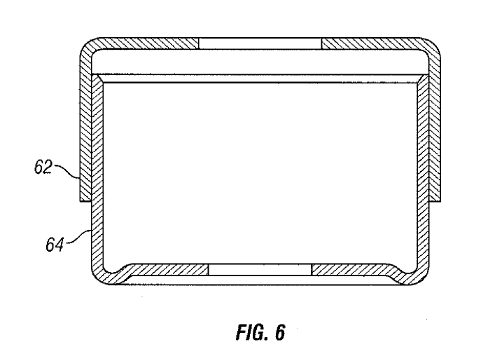

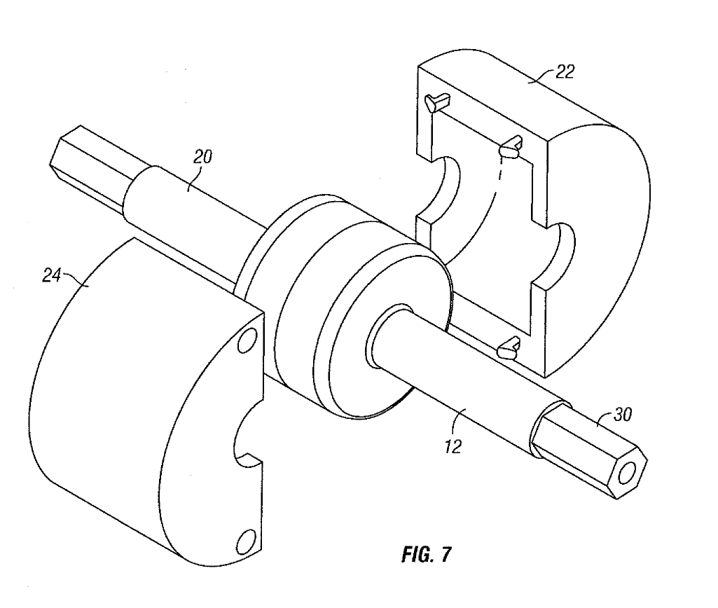

As shown, the second end 28 of the input member 12 terminates with a fastener 40 (FIG. 3) for coupling the second end 28 of the input member 12 with the pin retaining member 18. In the embodiment shown, the fastener 40 includes external threads 42 (FIG. 3) that are received by internal threads 43 in the pin retaining member 18. Although a threaded connection is shown for purposes of example, it should be appreciated that the input member 12 could be coupled with the pin retaining member 18 in other manners, such as an interference or frictional fit.

In the example shown, a plurality of shear pins 14 are disposed in the pin retaining member 18. Although this example shows six shear pins 14 for purposes of example, there could be less shear pins 14 or more shear pins 14. The number of shear pins 14 could be chosen depending on the number of times that the torque limiting driver 10 is configured to reach its maximum torque. As discussed below, a single shear pin 14 shears each time the torque limiting driver reaches the maximum torque in one embodiment. Consider a medical procedure in which six bone screws were intended to be used. In this embodiment, a shear pin 14 would shear each time a bone screw is screwed into the maximum torque. At the end of this example procedure with six bone screws, each of the shear pins 14 would have sheared. Accordingly, after each shear pin 14 has sheared, the torque limiting driver 10 could be disposed of, which would eliminate the need for re-sterilization and recalibration of the torque limiting driver 10. Alternatively, embodiments are contemplated in which a new set of shear pins 14 could be loaded into the pin retaining member 18. For example, pins could be loaded similar to a revolver. Rotate the revolver and load one pin, break pin, and then rotate revolver to load a new pin. Other embodiments contemplate shear pins extending radially from circumferential slots into another structure that shears the pins upon reaching the desired torque. Embodiments are also contemplated in which other devices could be used to sequentially release a torque load between the input assembly and the output member without shearing any pins, including teeth and magnets.

As shown, the shear pins 14 include a head portion 44 and a pin portion 46. In this embodiment the head portion 44 is sized to be substantially tightly-fit between the second end 28 of the input member 12 and an interior surface 48 of the pin retaining member 18 (as best seen in FIG. 3). Each of the pin portions 46 are received in respective holes 50 in the pin retaining member 18. In one embodiment, the edges of the holes 50 are chamfered to aid in the shearing process. The head portions 44 are sized to prevent the shear pins from falling through the holes 50.

As best seen in FIG. 3, the pin portions 46 extend into respective slots 52 defined in the output member 20. As discussed below, the slots 52 are configured to sequentially shear a shear pin 14 each time the maximum torque is reached. The maximum torque could be based upon (among other things) the diameter of the pin, the distance of the pin from the central axis, and the depth of the clearance groove at the site of the pin. In the embodiment shown, the slots 52 are arcuately shaped. The length of the slots 52 are progressively longer so that only a single shear pin 14 is sheared each time the maximum torque is exceeded. Typically, the slots 52 are dimensioned to hold sheared portions of the shear pins 14. For example, the slots could have sufficient depth to receive the sheared portion of the pin. Typically, the slots would be wide enough to prevent drag on the sides of the slots with the pins. In some cases, the slots 52 could be associated with one or more magnets to retain the pin fragments within the slots 52. Although the slots are arranged for clockwise movement in the example shown, it should be appreciated the torque limiting driver 10 could be configured to drive in a counterclockwise direction. Embodiments are contemplated in which the pins 14 could extend approximately perpendicularly to the axis of rotation. In such an embodiment, for example, the pins could extend into slots in the circumferial wall of the pin retaining member 18.

Other embodiments are contemplated for limiting the maximum torque for the torque limiting driver 10. For example, a single pin (longer than those shown in the drawings) could be spring loaded within the input assembly. Once the housing assembly is fit together, then the input member 12 would be rotated until the pin snapped into a bottom hole in the output member 20. The pin would be sheared, thus resulting in a pre-selected amount of torque. The input member 12 could be rotated until the pin drops into another hole and then the pin would be sheared again upon reaching the maximum torque. This procedure would be repeated using up the remainder of the pin and filling all holes with pin fragments. The breaking of the pin would be accomplished by a consistent force which would be dependent on pin geometry and diameter of rotation among other factors.

In another embodiment, the maximum torque could be established using the pull of magnets to determine a constant force. Breaking of magnetism would be accomplished at a consistent torque. For example, different size of magnets could be used depending on what torque needs to be accomplished.

In another embodiment, teeth similar to a ratchet-like device could be used to establish the maximum torque. For example, it would take a certain amount of torque to get up the incline of the teeth, thus resulting in a consistent torque. The teeth could be made in either direction and there would be no clockwise turning and then inadvertent counterclockwise turning in the process. In another embodiment, the gear teeth could be vertical with a pin backed by a spring and set screw (or all of this could be in the form of a ball plunger) to create a variable piece that engages the teeth. The torque could be adjusted by tweaking the spring via the set screw.

Referring again to FIGS. 1-3, the pin retaining member 18 includes a central hole 54 that is dimensioned to receive a finger member 56. In the embodiment shown, the input assembly rotates about the finger member 56. Due to the shear pins 14 extending into the slots 52, torque is applied to a shear pin 14 until it shears when the maximum torque is reached. The opposing end of the output member 20 includes a fastening portion 58. As shown, the fastening portion 58 is adapted to releasably attach a medical instrument. Embodiments are contemplated in which a variety of connection types and styles could be used for the fastening portion 58, including but not limited to a male-type fastener, female-type fastener, a square connection, and/or an AO style connection. Typically, the fastening portion 58 would be a quick connect, including but not limited to the embodiments shown in FIGS. 10-13 and discussed below.

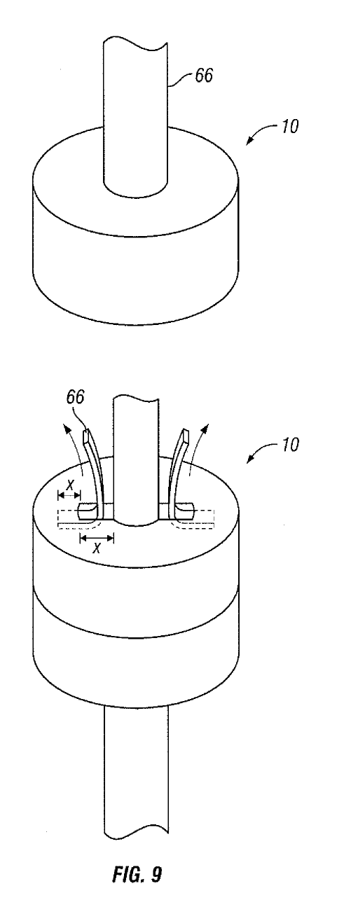

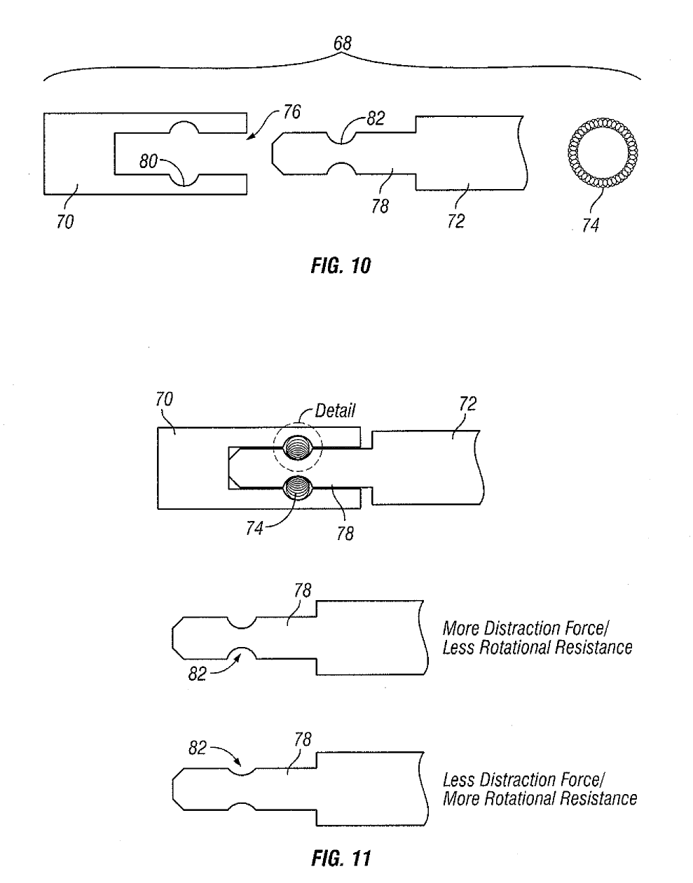

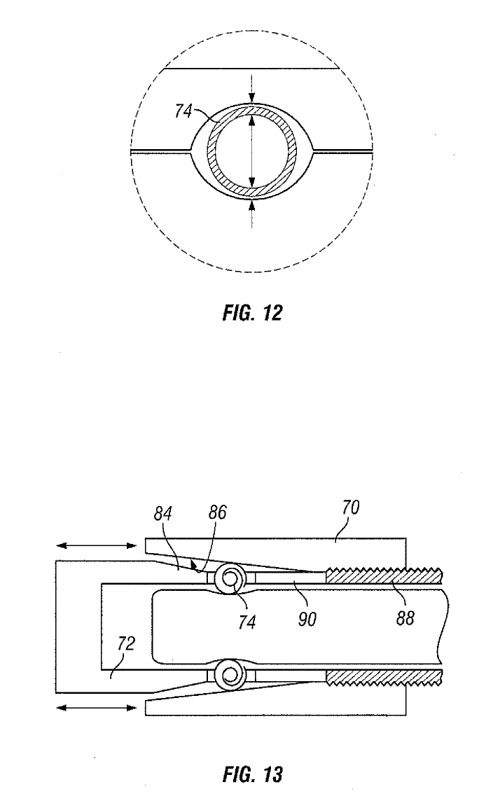

In the embodiment shown, the housing assembly is a clam-shell style design. In some embodiments, the housing assembly could be formed from plastic or metal (such as stainless steel). As shown, the first housing member includes hooks 60 that are received in slots (not shown) in the second housing member 24. FIGS. 4-6 show an alternative embodiment for the housing assembly. In the embodiment shown, a first member 62 is received by a second member 64. Typically, this would be a press fit arrangement.

FIG. 9 shows an embodiment in which a removable strip 66 could be used to maintain a specific gap between internal components of the torque limiting driver 10 during assembly. For example, it may be advantageous to maintain a specific gap between the housing assembly and input member or output member during assembly. Once assembled, the strip 66 could be removed. An embodiment is also contemplated in which a dissolvable member could be used to maintain a gap between internal components in the torque limiting driver 10. In such an embodiment, the torque limiting driver 10 could be submerged in a fluid, such as alcohol, that would dissolve the dissolvable member.

FIGS. 10-12 show an embodiment of a quick connect mechanism 68 which could be used in the torque limiting driver 10. It should be appreciated by one skilled in the art that the quick connect mechanism 68 could be used in devices other than the torque limiting driver 10. The discussion of the quick connect mechanism 68 herein in regards to its application on the torque limiting driver 10 is for example purposes only. In the embodiment shown, the quick connect mechanism 68 comprises a female connection 70, a male connection 72 and an interference device 74. In the embodiment shown, the female member 70 includes a cavity 76 that is dimensioned to receive an extension portion 78 on the male connection 72. A circumferential groove 80 is defined in the cavity 76 to hold the interference device 74. The groove 80 maintains a fixed lateral position of the interference device 74 and has a depth so that at least a portion of the interference device 74 is exposed within the cavity 76. A groove 82 is defined in the extension portion 78 to approximately correspond with the depth of the circumferential groove 80 within the cavity 76. This allows the groove 82 to receive the exposed portion of the interference device 74, which tends to maintain the locked position of the male connection 72 due to frictional resistance between the interference device 74 and the groove 82 on the extension portion 78. The interference device 74 could be a spring, o-ring or other resilient member that could provide functional interference to releasably lock the members 70 and 72. This frictional resistance can be overcome by pulling on the male connection 72 to unlock the male connection 72. As best seen in FIG. 11, the depth of the circumferential groove 80 and the groove 82 could be varied to vary the amount of force needed to insert/remove the male connection 72. Likewise, the depth could be configured to adjust the axial movement between the female connection 70 and the male connection 72. In other words, the interference device 74 could be configured to limit rotation between the female connection 70 and the male connection 72. For example, as seen in FIG. 12, the area of friction between the female connection 70 and the male connection 72 could be used to adjust the maximum torque that could be transferred between the female connection 70 and the male connection 72. Embodiments are contemplated in which ridges could be provided on groove 82 and circumferential groove 80 to set the force needed to rotate the female connection 70 with respect to the male connection 72.

An embodiment shown in FIG. 13 includes a male connection 72 without a groove. Instead a leading portion 84 is tapered to frictionally engage a tapered portion 86 of the female member 70. The biasing member 74 and an adjustable sleeve provide frictional areas to maintain a connection between the male member 72 and female member 70. In this embodiment, threads 88 are provided to linearly adjust the sleeve 90, which adjusts the amount of force that is needed to insert/withdraw the male member 72. Likewise, this adjustable area of friction could be used to adjust the torque that could be transferred between the members 70 and 72.

Consider an example operation of the torque limiting driver 10 during a surgery in which six bone screws are intended to be secured at a predetermined torque. The surgeon could receive a kit with six bone screws, along with the torque limiting driver 10 configured with a preselected torque for the bore screws to be used during the surgery. In this example with six bore screws to be attached, the torque limiting driver 10 could include six shear pins 14. The surgeon would typically attach a medical instrument to the fastener portion 30, such as a handle. As discussed above, this could be with the use of the quick connect mechanism described with respect to FIGS. 10-13. On the opposing end, the surgeon would place a bone screw. In order to attach the bone screw, the surgeon would torque the input member 12, which would transfer torque to the output member 20, thereby driving the bone screw. When the maximum torque has been reached, the shear pin 14 would shear in the embodiment shown, which would prevent the bone screw from being over-torqued. The surgeon would feel the resistance decrease due to the shearing of the shear pin 14 and would, therefore, know that the maximum torque had been reached for that bone screw. Additionally, the surgeon would likely hear the shearing of the shear pin 14 which would provide an audible feedback indicator that the maximum torque has been reached. The surgeon would then place another bone screw on the torque limiting driver 10. The process would continue until the surgeon has attached all the bone screws or until each shear pin 14 has been sheared.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed:

1. A torque limiting driver for applying up to a maximum torque to an associated driven member, the torque limiting driver comprising:
a first rotatable member having a proximal end and a distal end;
a second rotatable member having a proximal end and a distal end;
a torque limiting assembly operatively coupling the distal end of the first rotatable member with the proximal end of the second rotatable member; and
wherein the torque limiting assembly includes a plurality of torque limiting devices that are arranged to sequentially uncouple the second rotatable member from a torque load applied to the first rotatable member when the torque load reaches a preselected maximum torque.

2. The torque limiting driver of claim 1, wherein at least one of the proximal end of the first rotatable member and the distal end of the second rotatable member includes a quick connect fastening portion.

3. The torque limiting driver of claim 2, wherein the quick connect fastening portion includes a female connection with a cavity dimensioned to receive a male connection, wherein an interference member is disposed within the cavity to frictionally couple the male connection with the female connection.

4. The torque limiting driver of claim 3, wherein a circumferential groove is defined in the cavity and the interference member is disposed in the groove.

5. The torque limiting driver of claim 4, wherein the male connection includes a circumferential groove with a depth dimensioned to receive a portion of the interference member when the male connection is coupled with the female connection.

6. The torque limiting driver of claim 5, wherein the interference member comprises a spring.

7. The torque limiting driver of claim 5, wherein the interference member comprises an o-ring.

8. The torque limiting driver of claim 4, further comprising one or more ridges defined in the circumferential groove to limit rotation between the female connection and the male connection.

9. The torque limiting driver of claim 3, wherein the female connection includes a tapered portion that is dimensioned to receive a tapered portion of the male connection.

10. The torque limiting driver of claim 1, wherein at least one of the torque limiting devices is selected from the group comprising a frangible member, a magnet, and a tooth.

11. A torque limiting driver for applying up to a maximum torque to an associated driven member, the torque limiting driver comprising:
a first rotatable member having a proximal end and a distal end;
a second rotatable member having a proximal end and a distal end;
a torque limiting assembly operatively coupling the distal end of the first rotatable member with the proximal end of the second rotatable member; and
wherein the torque limiting assembly includes a frangible member configured to release the second rotatable member from a torque load applied to the first rotatable member when the torque load reaches the preselected maximum torque.

12. The torque limiting driver of claim 11, wherein the frangible member is configured to provide an audible indication that the torque load on the first rotatable member reaches the preselected maximum torque.

13. The torque limiting driver of claim 11, wherein the frangible member is a shear pin.

14. The torque limiting driver of claim 11, wherein the frangible member is metallic and further comprising a magnet associated with the torque limiting assembly for retaining portions of the frangible member within the torque limiting assembly.

15. The torque limiting driver of claim 11, wherein the torque limiting assembly includes a plurality of frangible members that are arranged approximately in a circle.

16. A torque limiting driver for applying up to a maximum torque to an associated driven member, the torque limited driver comprising:
a first rotatable member having a proximal end with a quick connect fastener portion and a distal end;
a second rotatable member having a proximal end and a distal end with a quick connect fastener portion;
at least one shear pin operatively coupling the first rotatable member with the second rotatable member; and
wherein the shear pin is configured to shear when a pre-selected torque is applied to the first rotatable member.

17. The torque limiting driver of claim 16, wherein the shear pin has a first end disposed within the first rotatable member and a second end extending into a slot defined in the second rotatable member.

18. The torque limiting driver of claim 17, wherein the slot includes an edge that shears the shear pin when the pre-selected torque is applied to the first rotatable member.

19. The torque limiting driver of claim 18, wherein the edge includes surface ornamentation.

20. The torque limiting driver of claim 16, wherein a plurality of shear pins operatively couple the first rotatable member with the second rotatable member.

21. The torque limiting driver of claim 20, wherein the shear pins are arranged to sequentially shear when the pre-selected torque is applied to the first rotatable member.

22. The torque limiting driver of claim 20, wherein the second rotatable member includes a plurality of slots and wherein the plurality of shear pins have a first end disposed within the first rotatable member and a second end extending into a respective slot of the plurality of slots defined in the second rotatable member.

23. The torque limiting driver of claim 22, wherein the plurality of slots are arranged to sequentially shear the shear pins when the pre-selected torque is applied to the first rotatable member.

24. The torque limiting driver of claim 23, wherein the plurality of slots have an arcuate shape.

25. The torque limiting driver of claim 24, wherein the plurality of slots have progressively larger lengths to sequentially shear the shear pins.

26. A method for driving a device in a torque limited manner, the method comprising the steps of:
providing a torque limiting driver comprising a torque limiting assembly operatively coupling a first rotatable member with a second rotatable member, wherein the torque limiting assembly includes a frangible portion that is configured to shear when a preselected maximum torque is applied to the first rotatable member;
applying a torque load to the first rotatable member; and
wherein the frangible member breaks when the torque load reaches the preselected maximum torque to release the second rotatable member from the torque load applied to the first rotatable member.

27. The method of claim 26, wherein the frangible portion includes a first shear pin and a second shear pin.

28. The method of claim 27, wherein the first shear pin breaks when an initial torque load reaches the preselected maximum torque.

29. The method of claim 28, wherein the second shear pin breaks when a subsequent torque load reaches the preselected maximum torque.

30. A kit for use by a health care provider, the kit comprising:
a medical device;
a single-use torque limiting driver having an end adapted to be coupled with the medical device, wherein the single-use torque limiting driver is capable of transferring torque to the medical device up to a preselected maximum torque;
wherein the single-use torque limiting driver is capable of reaching the preselected maximum torque no more than a preselected number of times.

31. The kit of claim 30, wherein the torque limiting driver comprises a first rotatable member operatively coupled with a second rotatable member using a shear pin, wherein the shear pin is configured to shear when a pre-selected torque is applied to the first rotatable member.

32. The kit of claim 31, wherein the shear pin has a first end disposed within the first rotatable member and a second end extending into a slot defined in the second rotatable member.

33. The kit of claim 31, wherein a plurality of shear pins operatively couple the first rotatable member with the second rotatable member.

34. The kit of claim 33, wherein the second rotatable member includes a plurality of slots and wherein the plurality of shear pins have a first end disposed within the first rotatable member and a second end extending into a respective slot of the plurality of slots defined in the second rotatable member.

35. The kit of claim 34, wherein the plurality of slots are arranged to sequentially shear the shear pins when the preselected torque is applied to the first rotatable member.

36. The kit of claim 35, wherein the plurality of slots have an arcuate shape.

37. The kit of claim 35, wherein the plurality of slots have progressively larger lengths to sequentially shear the shear pins.

38. The kit of claim 33, wherein the preselected number of times the torque limiting driver is capable of reaching the preselected maximum torque corresponds to the number of shear pins.
